(19) United States
(12) Patent Application Publication
(10) Pub. No.: US 2018/0361897 A1
(43) Pub. Date: Dec. 20, 2018

(54) VEHICLE SEAT PADDING ASSEMBLY WITH MOLDED-IN BLADDERS

(71) Applicant: Ford Global Technologies, LLC, Dearborn, MI (US)

(72) Inventors: Jeroen Lem, Maastricht (NL); Brian Boland, Pinckney, MI (US)

(73) Assignee: Ford Global Technologies, LLC, Dearborn, MI (US)

(21) Appl. No.: 15/628,119

(22) Filed: Jun. 20, 2017

(51) Int. Cl. B60N 2/66; B60N 2/44; B60N 2/64

(52) U.S. Cl. CPC B60N 2/665; B60N 2/4415; A47C 7/467; B60N 2/643; B60N 2/646

(57) ABSTRACT

A padding assembly for a vehicle seat includes a foam mass defining a first side and a bladder unit recessed into the first side of the foam mass within an impression defined by the bladder unit. The bladder unit has a first surface adhered to the foam mass on the first side thereof and defines an impression along the first side of the foam mass. The padding assembly further includes an air line coupled with the bladder unit and extending at least partially through the foam mass.

### FIELD OF THE DISCLOSURE

The present disclosure generally relates to a padding assembly for a vehicle seat. In particular, the padding assembly includes one or more bladder units embedded in a foam mass.

### BACKGROUND OF THE DISCLOSURE

Certain known vehicle seats include adjustment or massage capabilities that are based on the inclusion of various pneumatic bladders and associated systems within the seat, including a pump to selectively inflate and, in some instances, deflate the bladders. In various implementations, the bladders can be layered with foam padding within the seat, including above (toward the seating surface) or below (away from the seating surface) the foam padding. When such bladders are positioned above foam, mounting of such bladders, as well as routing of associated air lines can be difficult or have diminished effectiveness. In particular, it may be difficult to reliably position the bladders over the foam without compressing the foam, which may result in movement of the bladders, or decreased comfort of the vehicle seat by way of added structure and support for the bladders. In particular, it may be difficult to maintain the position of the bladders, depending on the number of mounting points and the particular tie-down force, both of which may compress the foam and alter the comfort characteristics of the seat. Additionally, it may be difficult to route the corresponding air lines around and under the foam padding, resulting in complicated structure or extra assembly steps.

### SUMMARY OF THE DISCLOSURE

According to one aspect of the present disclosure, a padding assembly for a vehicle seat includes a foam mass defining a first side and a bladder unit recessed into the first side of the foam mass within an impression defined by the bladder unit. The bladder unit has a first surface adhered to the foam mass on the first side thereof and defines an impression along the first side of the foam mass. The padding assembly further includes an air line coupled with the bladder unit and extending at least partially through the foam mass.

Embodiments of the first aspect of the invention can include any one or a combination of the following features:
the first surface of the bladder unit is adhered to the foam mass along an integral adhesion layer;
the bladder unit includes a backing layer defining at least a portion of the first surface;
the backing layer defines at least one permeable element, and a portion of the foam mass extends into the at least one permeable element to couple the backing layer to the foam mass within the impression;
the bladder unit further includes first and second air bladders coupled with the backing layer, the air line being a first air line and being coupled with the first air bladder;
the padding assembly further includes a second air line coupled with the second air bladder and extending at least partially through the foam mass;
the backing layer defines at least one protrusion extending into the foam mass to couple the backing layer to the foam mass within the impression;
the air line extends through the foam mass along a first portion of the air line that is enclosed within the foam mass, and a second portion of the air line extends outwardly from the foam mass;
the bladder unit is a first bladder unit, the impression is a first impression and the air line is a first air line, and the assembly further includes a second bladder unit recessed into the first side of the foam mass within a second impression defined by the second bladder unit and having a first surface adhered to the foam mass within the second impression and a second air line fluidically coupled with the second bladder unit and extending at least partially through the foam mass;
the first and second impressions are within respective first and second areas of the first surface of the foam mass; and
the padding assembly further includes a manifold fluidically coupled with the air line and a pump external to the foam mass and fluidically coupled with the manifold.

According to another aspect of the present disclosure, a vehicle seat includes a cushion, a seatback coupled with the cushion, and a first padding assembly within one of the cushion and the seatback. The padding assembly includes a first bladder unit defining a first surface and a first foam mass defining a first side. The first bladder unit defines an impression on the first side, and the first surface of the first bladder unit is adhered to the first foam mass along the impression.

According to another aspect of the present disclosure, a method for making a padding assembly for a vehicle seat includes positioning a bladder unit within a mold cavity. The bladder unit has an air line coupled therewith with a portion thereof extending within the mold cavity. The method further includes injecting foam into the mold cavity to at least partially surround and adhere to a portion of the bladder unit and to surround the portion of the air line.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective cutaway view of a vehicle seat having a padding assembly according to an aspect of the disclosure;

FIG. 2 is a detail view of the padding assembly of FIG. 1;

FIG. 3 is a cross-section view of a portion of the vehicle seat of FIG. 1 including the padding assembly thereof;

FIG. 4 is a cross-section view of an alternative padding assembly according to another aspect of the disclosure;

FIG. 5 is a cross-section view of an alternative padding assembly according to another aspect of the disclosure;

FIG. 6 is a cross-section view of an alternative padding assembly according to another aspect of the disclosure;

FIG. 7 is a cross-section view of a mold used in a method for making a padding assembly according to the disclosure;

FIG. 8 is a cross section view of a bladder unit for the padding assembly within a cavity of the mold;

FIG. 9 is a cross section view of the mold being filled with uncured foam to surround the bladder unit; and

FIG. 10 is the resulting padding assembly removed from the mold.

### DETAILED DESCRIPTION OF THE PREFERRED EMBODIMENTS

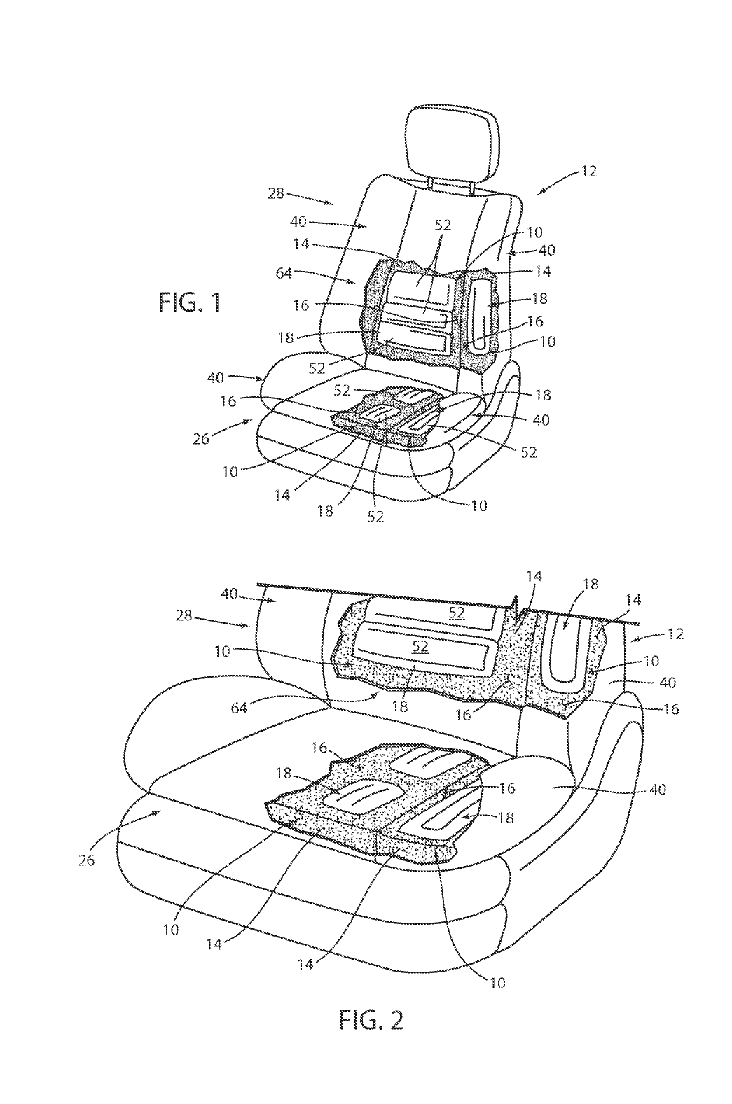

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

Referring to FIGS. 1-3, reference numeral 10 generally designates a padding assembly for a vehicle seat 12. The padding assembly 10 includes a foam mass 14 defining a first side 16, a bladder unit 18 having a first surface 22 adhered to the foam mass 14 on the first side 16 thereof. The bladder unit 18 defines an impression 20 along the first side 16 of the foam mass 14. The assembly 10 further includes an air line 24 coupled with the bladder unit 18 and extending at least partially through the foam mass 14.

As shown in FIGS. 1 and 2, the padding assembly 10 can be included in vehicle seat 12, which includes a cushion 26 and a seatback 28 coupled with the cushion 26. In this manner, vehicle seat 12 can include multiple padding assemblies 10 distributed, as desired, among the cushion 26 and the seatback 28. The particular configuration of such distributed padding assemblies 10, including the size, positioning, and number of bladder units 18, as well as the shape, thickness, etc. of the respective foam mass 14 can vary with the positioning of the padding assembly 10 within the vehicle seat 12 in a manner similar to the configuration of separate foam masses 14 and bladder units 18 that may otherwise be found in a similar vehicle seat. To that end, the inclusion of bladder units 18 within one or more foam masses 14 can provide for the desired positioning and support of bladder units 18 within the respective areas of vehicle seat 12 without additional structures affixing and supporting bladder units 18, thereby allowing the padding assemblies 10 described herein to be assembled into vehicle seat 12 to provide both foam padding and adjustably inflatable bladders therein in a single unit. As described further below, the padding assembly 10 can be made by molding the foam mass 14 over portions of the bladder units 18 to partially embed the bladder units 18 in the foam mass 14. In this manner, the impressions 20 defined in the foam mass 14 by the bladder units 18 are positioned and derived by the act of molding the foam mass 14 over the bladder units 18, which further results in at least some level of adherence between foam mass 14 to bladder units 18 in the areas where the foam mass 14 contacts bladder units 18 during such molding, as described further below. In various aspects, the characteristics, including the depth of the impressions 20 can vary. For example, in an embodiment, the bladder units 18 may be positioned generally outside of the foam mass 14 with the impression 20 being positioned generally entirely along the exterior surface of foam mass 14 defined by first side 16. In this manner, the impression 20 may simply reflect the shape and surface quality or character (including variations and imperfections, for example) of first surface 22 of bladder unit 18. In other embodiments, bladder units 18 may extend into foam mass 14 such that impression 20 defines a recess or cavity within foam mass 14 that reflects additional aspects of the three-dimensional shape of bladder unit 18, examples of which are discussed further below.

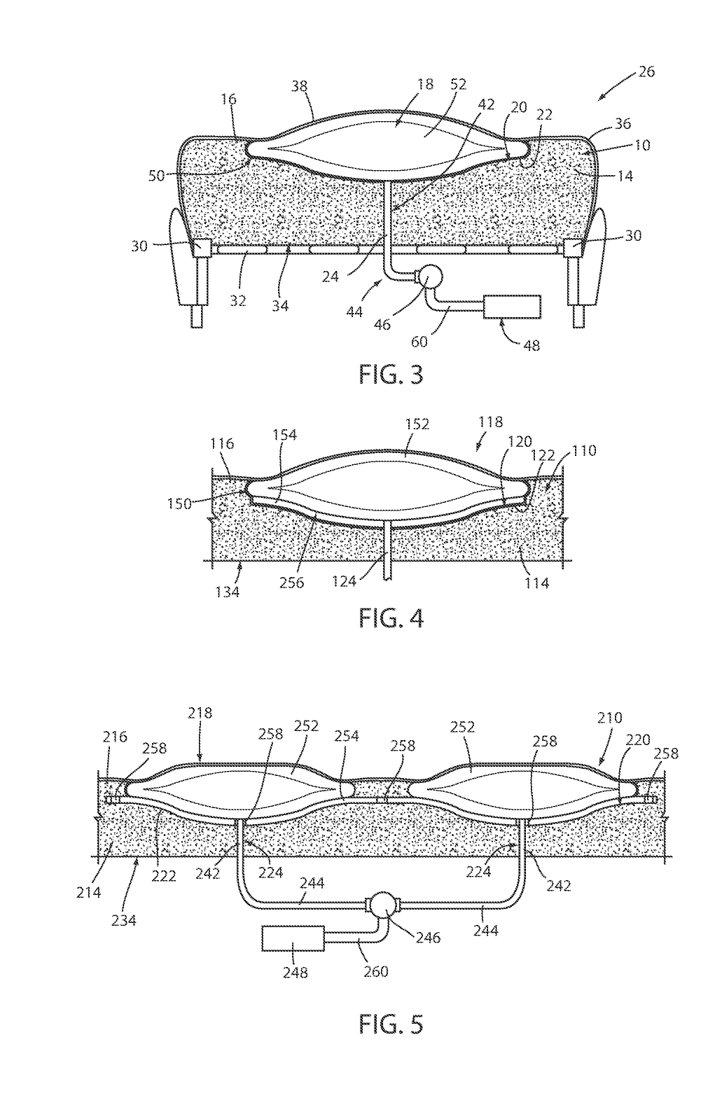

As shown in FIG. 3, both the seatback 28 and the cushion 26 of vehicle seat 12 may be constructed in a manner similar to those of other vehicle seats in which the general shape of the seatback 28 and cushion 26 are defined by respective frames 30 with one or more springs 32 (which may be serpentine springs or the like) spanning an open area within the frame 30. In this manner, the one or more springs 32 may act as support elements for the foam mass 14, which may contact, rest on, or be coupled with the support element along a second side 34 of foam mass 14 opposite first side 16. As further illustrated, a coverstock 36 overlying foam mass 14 to define a portion of the exterior of vehicle seat 12, including the portion of the seating surface 38 on the respective one of the cushion 26 or seatback 28 overlying foam mass 14. In this manner, the first side 16 of the foam mass 14 can define the profile of the vehicle seat 12 in the area under which foam mass 14 is positioned and bladder unit 18 can be inflated or deflated to adjust that profile and/or the support provided by assembly 10 to the corresponding seating profile. It is further noted that in other areas of vehicle seat 12, such as in bolsters 40 (FIGS. 1 and 2), for example, the supporting element may be defined by a carrier or the like that may be anchored to frame 30. In some further application, such a carrier may be moveable by way of additional springs, a motor, linear actuator, or the like. In such an instance, the corresponding foam mass 14 may be adapted for being supported by and affixed with such a carrier and the corresponding bladder unit 18 may be configured to adjust the corresponding portion of the seating surface 38 accordingly.

As further shown in FIG. 3, first air line 24 is fluidically coupled with the bladder unit 18 so as to be in fluidic communication therewith for providing a flow of air into or out of bladder unit 18 to pressurize or de-pressurize bladder unit 18. To couple with bladder unit 18, air line 24 can have a first portion 42 extending through foam mass 14. As shown, the first portion 42 of air line 24 can be embedded within and surrounded by foam mass 14 such that air line 24 can couple with bladder unit 18 in an area that can be, for example, itself embedded within foam mass 14. Further, a second portion 44 of air line 24 can extend outwardly from foam mass 14 in an area remote from bladder unit 18. As illustrated, an embodiment of padding assembly 10 can be such that the bladder unit 18 is positioned within foam mass 14 such that a portion thereof extends above or generally contiguously with first side 16 of foam mass 14 with such portion of bladder unit 18, along with first side 16 of foam mass 14 underlying and supporting coverstock 36 on what may be referred to as the A-side of the padding assembly 10. In such an implementation, the second side 34 of foam mass 14 can be what may be called the B-side of the padding assembly 10 and may, accordingly, face the interior of vehicle seat 12, which includes the above-described supporting element on which padding assembly 10 is supported. As further illustrated, the interior of vehicle seat 12 may also include a manifold 46 with which air line 24 may be coupled for the distribution of pressurized air from a pump 48 to bladder unit 18, as discussed further below. In this manner, the first portion 42 of air line 24 may extend from bladder unit 18 adjacent first side 16 of foam mass 14, through foam mass 14, and to location along second side 34 of foam mass 14, thereby allowing the second portion 44 to be positioned entirely within the interior of vehicle seat 12 (i.e. on the B-side of padding assembly 10) and external to foam mass 14 to couple with manifold 46. This construction of padding assembly 10 may, accordingly, provide for simplified routing of multiple air lines 24, such as in an implementation of vehicle seat 12 that includes a plurality of bladder units 18 or other arrangement discussed below that include multiple air lines 24 within a single seat 12 that couple with a single pump 48 (such as through one or more manifolds 46).

As also shown in FIG. 3, adhesion between bladder unit 18 may occur along an adhesion layer 50 defined along a contact area between foam mass 14 and bladder unit 18. In various implementations that depend on the particular material and construction of bladder unit 18 and the composition of foam mass 14, the adhesion layer 50 may extend into a portion of foam mass 14 and/or bladder unit 18. In the embodiment depicted in FIG. 3, for example, bladder unit 18 may consist of a singular air bladder 52 of a flexible, generally fluidically impermeable material. (It is noted herein that a single air bladder 52 of the type depicted generally in FIG. 3, may include multiple chambers or cells therein, defined within a single air bladder 52, although only a single chamber construction is depicted.) In such an implementation, foam mass 14 may flow against, but not into, air bladder 52 of bladder unit 18 during molding of foam mass 14, as discussed below, resulting in the adhesion layer 50 being realized along the outside surface of air bladder 52. As foam mass 14 may be made of a flowable material that can compress during molding, a portion of the foam mass 14 may be compressed in the area of contact with air bladder 52, such compression resulting in foam mass 14 being generally more smooth and/or less porous along adhesion layer 50, thereby sealing against air bladder 52 to provide some level of adhesion. In such an implantation, the smooth, non-porous construction of air bladder 52 may result in a low-level of adhesion, which is considered herein as still providing some amount of retention to foam mass 14 and including an adhesion layer 50 along the portions of foam mass 14 generally attributable to such adhesion that results in foam mass 14 being molded over bladder unit 18, including over air bladder 52, as discussed further below. Still further, the material used for foam mass 14 may be somewhat sticky or otherwise possess adhesive properties before curing, which may promote adhesion with bladder unit 18 during the molding process that may remain after curing.

Turning now to FIG. 4, an embodiment of padding assembly 110 is shown that is generally similar to that which is described above and can be similarly adapted for assembly into a vehicle seat 12 in various areas thereof In the embodiment shown in FIG. 4, the bladder unit 118 included in padding assembly 110 may include a backing layer 154 bonded or otherwise coupled with air bladder 152. In this manner, backing layer 154 can include an engageable feature to improve coupling of bladder unit 118 with foam mass 114. In the present example, the engageable feature is realized by backing layer 154 being of or otherwise including a porous material. In one example, backing layer 154 can be of a porous material that can allow inflow of the material used for foam mass 114 during fabrication thereof to extend adhesion layer 150 into bladder unit 118 such that adhesion layer 150 includes an integral composite of both backing layer 154 and foam mass 114 to improve coupling and/or adherence of bladder unit 118 with foam mass 114.

In various examples backing layer 154 can be of or can include a bonded filament, a mesh, or a foam material structured to allow such inflow. In a particular example, a backing layer 154 including the just mentioned structures can be fabricated of a polymeric material that can be bonded to air bladder 152 during the manufacturing process, including by heating or the like. In this manner, air bladder 152 can be made of a polymeric film with upper and lower sheets bonded together along outer and, optionally, inner seams thereof by heating to fuse the sheets together in the desired areas to form the desired chamber(s) within air bladder 152. Similarly, backing layer 154 can be of a material with similar properties including melting temperature, coefficient of thermal expansion, and the like, so that backing layer 154 can be bonded with, for example, the lower sheet of air bladder 152 during fabrication of air bladder 154. In one instance, the upper and lower sheets of air bladder 152 and backing layer 154 can be bonded simultaneously to result in the assembled bladder unit 118 with backing layer 154 bonded with air bladder 154, as depicted in FIG. 4. Other sequences and processes are possible to arrive at a similarly structured bladder unit 118, including bonding backing layer 154 with air bladder 152 after fabrication of air bladder 152 using adhesives, heat stakes, or mechanical fasteners to bond with the seams of air bladder 152 (thereby not puncturing the chamber or the like) including snaps, staples, rivets, or the like.

Turning now to FIG. 5, a further alternative arrangement for padding assembly 210 is shown in which bladder unit 218 includes multiple air bladders 252 on a single backing layer 254. Such an arrangement can be used to provide multiple, separately adjustable areas within an otherwise unitary area of vehicle seat 12, such as the central area of cushion 26 of the vehicle seat 12 depicted in FIGS. 1 and 2, in which four bladders 52 are positioned within separate areas of the padding assembly 10 associated therewith. As shown in FIG. 5, this assembly 210 can be achieved by including a backing layer 254 that is at least as large as the desired area to be occupied by the various air bladders 252 included in bladder unit 218. To that end, the various different air bladders 252 to be included in bladder unit 218 can then be coupled with backing layer 254 in the desired locations. In this manner, a plurality of air bladders 252 can be provided in a single impression 220 within foam mass 214 with the first surface 222 of bladder unit 218 corresponding with the outer surface of backing layer 254 for adhesion with foam mass 214 within impression 220.

As discussed above, the air bladders 252 can be coupled with backing layer 254 in various ways, depending on the material and/or configuration of air bladders 252 and backing layer 254. In one example, backing layer 254 can be of one of the constructions discussed above, including a permeable element of structure and can be bonded with the various air bladders 252 as discussed above. In the depicted example, backing layer 254 can be of a generally solid (i.e. impermeable) material that can instead include engageable features in the form of various apertures 258 extending therethrough in a distributed manner. In an example, the apertures 258 can be located in areas between or surrounding the various air bladders 252. In this manner, portions of foam mass 214 can permeate or otherwise extend through apertures 258 and engage with backing layer 254 on opposing sides thereof extending away from apertures 258 to structurally couple backing layer 254 and, therefore, bladder unit 218 with foam mass 214. Such a construction may allow backing layer 254 to be of a relatively thick polymeric film material (e.g., between about 2 mm and 4 mm), with corresponding rigidity, or of a foil material, for example, to provide for reliable placement of bladder unit 218 during fabrication.

To provide the above-mentioned flow of air into and out of the various air bladders 252 in bladder unit 218, padding assembly 210 can include a corresponding plurality of air lines 224 fluidically coupled with each of the air bladders 252 respectively. In a manner similar to that which is discussed above with respect to FIG. 3, the various air lines 224 can each extend through foam mass 214 along respective first portions 242 thereof from air bladders 252 to respective second portions 244 thereof that exit foam mass 214 along second side 234 thereof to couple with manifold 246 for distribution of air among the various bladders 252 from pump 248. To facilitate such distribution of air, manifold 246 may include a plurality of valves respectively associated with the various ones of the air lines 224 selectively open and close air lines 224 to pump 248 for inflation thereof. In a similar manner, such valves may be configured to individually vent the air lines 224 (such as to the ambient environment or the like) for deflation thereof. To allow air lines 224 to extend from adjacent the first side 216 of foam mass 214 therethrough, backing layer 254 can include apertures 258 in a location or locations such that air lines 224 can extend therethrough. In this manner, various apertures 258 can be included in backing layer 254 adjacent the coupling points of air lines 224 with air bladders 252 to generally immediately route through backing layer 254. In an alternative arrangement, air lines 224 can extend along the A-side of backing layer 254 (i.e. adjacent first side 216 of foam mass 214) to route to a single aperture 258 or a plurality of adjacent apertures 258 in, for example, a central portion of backing layer 254 before extending toward second side 234 of foam mass 214.

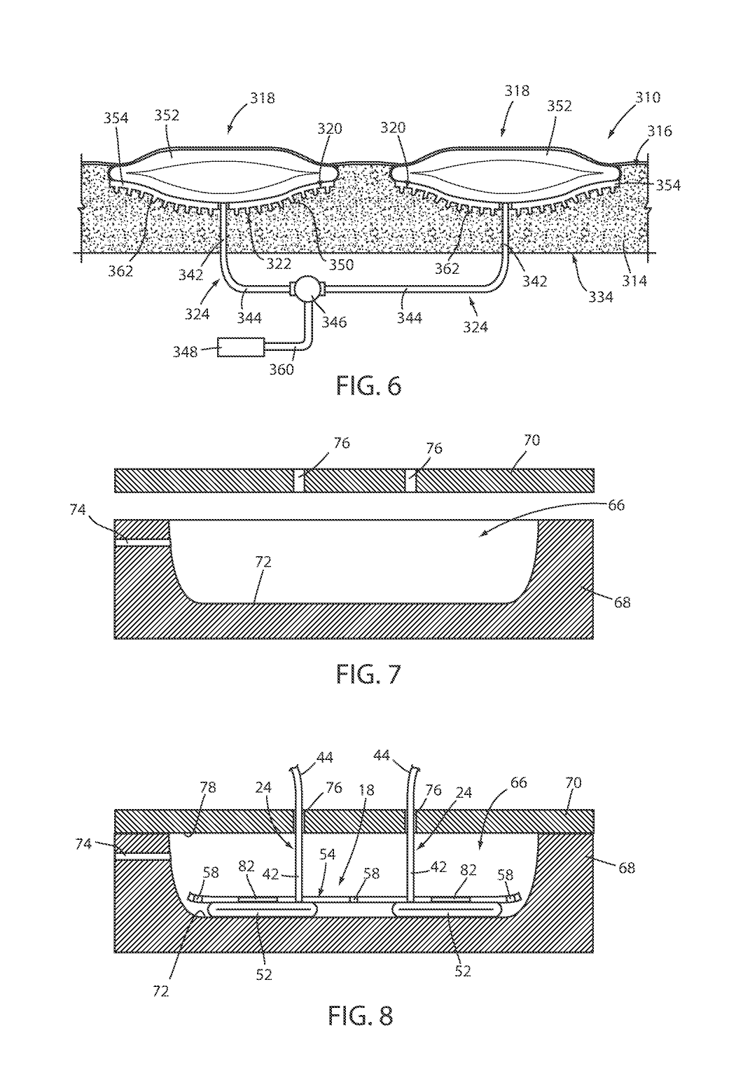

Turning now to FIG. 6, a further arrangement for a padding assembly 310 having multiple air bladders 352 therein is described. In particular, each such air bladder 352 can be in a separate bladder unit 318, each with a respective backing layer 354. In an example, such an arrangement can be similar to one in which a padding assembly 10 or 110 includes multiple bladder units 18 or 118 similar to those shown in FIGS. 3 and 4 and described with respect thereto within such an assembly 10 or 110. To that end, as shown in FIG. 6, each such bladder unit 318 can be positioned within a desired area of first side 316 of foam mass 314 and, accordingly, be adhered to foam mass 314 along the first surface 322 of each bladder unit 318 (such first surface 322 being defined on the backing layer 354, for example) in a corresponding individual impression 320 associated with each bladder unit 318. Further, each bladder unit 318 may have an air line 324 coupled therewith by way of the respective air bladder 352 thereof. In a manner similar to that which is discussed above, each such air line 324 may extend along respective first portions 342 thereof through foam mass 314 to second portions 344 extending outwardly from foam mass 314 along second side 334 thereof. It is noted that the first portions 342 of air lines 324 can route through foam mass 314 in the generally direct manner of FIG. 6 or can route though foam mass 314 to a common area along second side 334 from which the second portions 344 can extend to couple with manifold 346. In yet another arrangement, manifold 346 can itself be fully or partially embedded within foam mass 314 with a secondary air line 360 extending from manifold 346 to the associated pump 348 or another manifold, depending on the particular arrangement thereof.

In various embodiments, the backing layers 354 can be of any of the types discussed above including a permeable material, as discussed above with respect to FIG. 4, or a material with apertures 258 similar to those discussed above with respect to FIG. 5 but in backing layers 354 sized to correspond with the individual air bladders 352. In the illustrated example, a further configuration for a backing layer 354 is illustrated that includes a plurality of protrusions 362 extending therefrom and into adjacent portions of foam mass 314. In this manner, the area of the adhesion layer 350 can be increased by the added surface area of backing layer 354 by protrusions 362. Still further, protrusions 362 may be T-shaped, L-shaped, may include apertures or permeable elements for add structural engagement between backing layer 354 and foam mass 314 in a similar manner to that which is discussed above.

Returning to FIGS. 1 and 2, as mentioned above, vehicle seat 12 can include various padding assemblies 10 according to any of the various arrangements discussed above, including combinations and reconfigurations thereof, to provide the desired number and arrangement of air bladders 52 therein. For example, as mentioned above, the padding assembly 10 within the central area of cushion 26 can include multiple air bladders 52 that can be in separately-positioned bladder units 18 or in an arrangement as shown in FIG. 4, wherein multiple air bladders 52 are included on a single backing layer 54 in a single bladder unit 18. Similarly, the lumbar area 64 of seatback 28 can include a bladder unit 18 having multiple vertically-arranged bladders 52 that can be arranged in an overlapping manner on a single backing layer 54. Further, the bolster 40 of both seatback 28 and cushion 26 can include separate padding assemblies 10 with individual bladders 52 therein in single bladder unit 18, which may include corresponding backing layers 54. Alternatively, the central area of seatback 28 or cushion 26 and the respective bolsters 40 may be included in a single padding assembly 10 which may include a single bladder unit 18 with multiple bladders 52 or multiple bladder units 18 with single or multiple air bladder 52 arrangements on common or separate backing layers 54 (or without backing layers 54, as shown in FIG. 1 in the case of single air bladder 52 bladder units 18). As also discussed above, the air bladder 52 in the various padding assemblies 10 can be coupled with respective air lines 24 routed through the various foam masses 14, as desired, to extend outwardly from the foam masses 14 in convenient locations for further extension to manifold 46 or manifolds 46 within vehicle seat 12, as desired for coupling with pump 48.

Turning now to FIGS. 7-10, various steps for fabricating a padding assembly 10, 110, 210, or 310 according to the various embodiments discussed above, are shown. In particular, the method may generally include positioning bladder unit 18 within a cavity 66 of a mold 68 or a portion thereof. As discussed above, the bladder unit 18 has air line 24 coupled therewith and is positioned within the cavity 66 such that the above-described first portion 42 (FIG. 5) extends within the cavity 66. Once bladder unit 18 and air line 24 are appropriately positioned within cavity 66, uncured foam 80 is injected into the cavity 66 to at least partially surround and adhere to a portion of the bladder unit 18 and to surround the portion of the air line 24.

More particularly, as shown in FIG. 7, the cavity 66 can be formed between first 68 and second 70 mold portions that can enclose cavity 66 in the desired shape of padding assembly 10, as desired for the particular placement of the assembly 10 to-be fabricated within vehicle seat 12. As shown, the first mold portion 68 can include a surface 72 that corresponds generally with the first side 16 of foam mass 14 (e.g., as shown in FIG. 3), including the desired seating profile for the areas surrounding bladders 52. As shown in FIG. 8, the bladder unit 18 (or bladder units 18, depending on the configuration thereof, as well as of padding assembly 10) can be positioned within cavity 66 against the surface 72 of first mold portion 68, particularly with air bladders 52 thereagainst to position air bladders 52 within the first side 16 of the foam mass 14 provided by the areas of surface 72 surrounding air bladders 52 in the resulting padding assembly 10. As further shown in FIG. 8, portions of bladder unit 18, including backing layer 54 and/or portions of air bladders 52 remote from surface 72 are positioned within cavity 66. Additionally, air lines 24 are positioned within cavity 66 to provide the desired routing therefore through foam mass 14, including toward the second mold portion 70, which can include one or more apertures 76 therethrough to receive air lines 24 therein. As shown, the second mold portion 70 is positioned oppositely from surface 72 of first mold portion 68 such that a surface 78 thereof defines the second side 34 of foam mass 14 (FIG. 3). In this manner, by positioning air lines 24 through apertures 76, first portions 42 of air lines 24 are within cavity 66 to be enclosed in foam mass 14 when formed therein with second portions 44 being outside of cavity 66 to extend outwardly from foam mass 14 at the second side 34 thereof. It is noted that the other illustrated mold portions 68 and 70 can be reconfigured to provide variations in the positioning and routing of air lines 24 through cavity 66.

In the depicted embodiment, the positioning of air bladders 52 along surface 72 of first mold portion 68 can be augmented by releasably affixing air bladders 52 with surface 72. In one example, this can be done by applying a releasable adhesive to air bladders 52 before applying pressure to bladder unit 18 to temporarily adhere air bladders 52 to surface 72. Alternatively, in the arrangement shown, bladder unit 18 can include one or more coupling elements 82 in the form of magnetic structures therein. As illustrated, the coupling elements 82 can be embedded within backing layer 54 in an area corresponding with the locations of air bladders 52. Accordingly, the coupling elements 82 can be magnetically attracted to first mold portion 68, which can be of or can otherwise include a ferrous metal such that the magnetic attraction between coupling elements 82 and first mold portion 68 can retain air bladders 52 against surface 72 when bladder unit 18 is positioned thereagainst. In similar arrangement, bladder unit 18 can include a ferrous component or structure therein, such as in the material used for backing layer 54 or elsewhere therein, that can be attracted to a magnetic element embedded within first mold portion 68. Such temporary coupling can help to maintain the desired positioning of bladder unit 18 within cavity 66, including during foam inflow, and can prevent foam from forming over air bladders 52, which could cause air bladders 52 to tear or otherwise damage corresponding portions of foam mass 14 when inflated, for example.

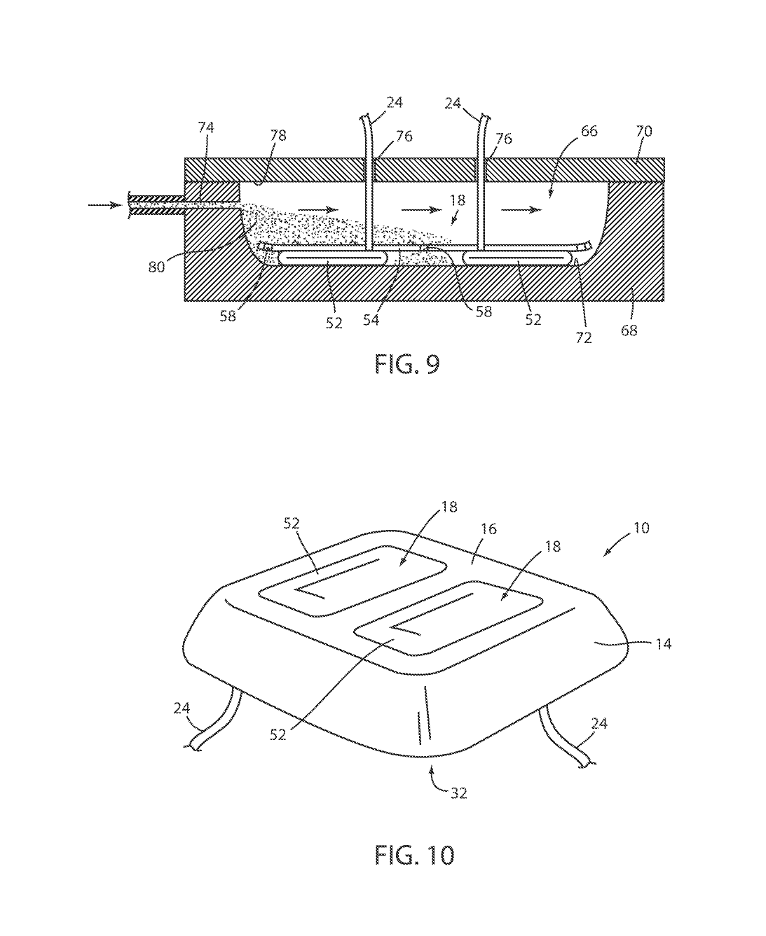

As shown in FIG. 9, uncured foam 80 may be injected or otherwise introduced into cavity 66 through one or more inlets 74 in first mold portion 68 (such an inlet 74 may additionally or alternatively be present in second mold portion 70). In particular, the uncured foam 80 may fill the portions of cavity 66 not otherwise occupied by bladder unit 18 or air lines 24 such that the uncured foam 80 takes the desired shape of foam mass 14, including that of first side 16 and second side 32 (FIG. 3) corresponding with the above-mentioned surfaces 72 and 78 of first and second mold portions 68 and 70. In this manner, the uncured foam 80 may surround first portions 42 of air lines 24 and bladder unit 18, including by flowing into any permeable elements (such as permeable elements 156 shown in FIG. 4) or apertures 58 or around any protrusions (such as protrusions 362, as shown in FIG. 6) including on or in backing layer 54 or elsewhere in bladder unit 18, thereby forming adhesion layer 50 (FIG. 3) according to any of the above-described variations thereof within a corresponding impression 20 (FIG. 3) defined by bladder unit 18. After injection, the uncured foam 80 is maintained within cavity 66 until curing occurs to arrive at the desired foam mass 14 and the resulting padding assembly 10, which can then be removed from the cavity 66 resulting in the padding assembly 10 shown in FIG. 10, for example with air bladders 52 embedded within foam mass 14 and retained therein at least by the adhesion layer 50 within the impression 20 that results from the molding process. Padding assembly 10 can subsequently be assembled into the appropriate location within vehicle seat 12, including coupling of air lines 24 with manifold 46.

It is to be understood that variations and modifications can be made on the aforementioned structure without departing from the concepts of the present disclosure, and further it is to be understood that such concepts are intended to be covered by the following claims unless these claims by their language expressly state otherwise.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A padding assembly for a vehicle seat, comprising:
a foam mass defining a first side;
a bladder unit having a first surface adhered to the foam mass on the first side thereof, the bladder unit defining an impression along the first side of the foam mass; and
an air line coupled with the bladder unit and extending at least partially through the foam mass.

2. The padding assembly of claim 1, wherein the first surface of the bladder unit is adhered to the foam mass along an integral adhesion layer.

3. The padding assembly of claim 1, wherein the bladder unit includes a backing layer defining at least a portion of the first surface.

4. The padding assembly of claim 3, wherein the backing layer defines at least one permeable element; and
a portion of the foam mass extends into the at least one permeable element to couple the backing layer to the foam mass within the impression.

5. The padding assembly of claim 3, wherein the bladder unit further includes first and second air bladders coupled with the backing layer, the air line being a first air line and being coupled with the first air bladder.

6. The padding assembly of claim 5, further including a second air line coupled with the second air bladder and extending at least partially through the foam mass.

7. The padding assembly of claim 3, wherein the backing layer defines at least one protrusion extending into the foam mass to couple the backing layer to the foam mass within the impression.

8. The padding assembly of claim 1, wherein:
the air line extends through the foam mass along a first portion of the air line that is enclosed within the foam mass; and
a second portion of the air line extends outwardly from the foam mass.

9. The padding assembly of claim 1, wherein the bladder unit is a first bladder unit, the impression is a first impression, and the air line is a first air line, the assembly further including:
a second bladder unit recessed into the first side of the foam mass within a second impression defined by the second bladder unit and having a first surface adhered to the foam mass within the second impression; and
a second air line fluidically coupled with the second bladder unit and extending at least partially through the foam mass.

10. The padding assembly of claim 9, wherein the first and second impressions are within respective first and second areas of the first surface of the foam mass.

11. The padding assembly of claim 1, further including:
a manifold fluidically coupled with the air line; and
a pump external to the foam mass and fluidically coupled with the manifold.

12. A seat, comprising:
a cushion;
a seatback coupled with the cushion; and
a first padding assembly within one of the cushion and the seatback, including:
a first bladder unit defining a first surface; and
a first foam mass defining a first side, the first bladder unit defining an impression on the first side, the first surface of the first bladder unit being adhered to the first foam mass along the impression.

13. The vehicle seat of claim 12, wherein:
the padding assembly further includes a first air line fluidically coupled with the first bladder unit; and
at least a portion of the first air line extends through the first foam mass.

14. The vehicle seat of claim 12, further comprising:
a second padding assembly within one of the cushion and the seatback and including:
a second bladder unit defining a first surface; and
a second foam mass defining a first side, the second bladder unit being recessed into the first surface of the second foam mass within an impression defined by the second bladder unit, the first surface of the second bladder unit being adhered to the second foam mass within the impression.

15. The vehicle seat of claim 14, wherein the first and second padding assemblies are positioned in the same one of the cushion and the seatback.

16. The vehicle seat of claim 12, wherein:
the first side of the first foam mass defines a seat surface supporting profile for the one of the cushion and the seatback; and
the padding assembly further includes a first air line fluidically coupled with the first bladder unit, a first portion of the first air line extending through the first foam mass and extending externally from the first foam mass along a second side of the first foam mass opposite the first side.

17. The vehicle seat of claim 12, wherein:
the one of the seatback and the cushion further includes a support element;
the first side of the first foam mass defines a seat surface supporting profile; and
a second side of the first foam mass opposite the side face is supported on the support element.

18. A method for making a padding assembly for a vehicle seat, comprising:
positioning a bladder unit within a mold cavity, the bladder unit having an air line coupled therewith with a portion thereof extending within the mold cavity; and
injecting foam into the mold cavity to at least partially surround and adhere to a portion of the bladder unit and to surround the portion of the air line.

19. The method of claim 18, wherein positioning the bladder unit within the mold cavity further includes releasably coupling the bladder unit with a first surface of the mold cavity.

20. The method of claim 18, wherein:
the bladder unit includes a backing layer including a first engageable feature; and
the step of injecting foam into the mold cavity further engages the foam with the first engageable feature.
